(19) United States
(12) Patent Application Publication
(10) Pub. No.: US 2021/0110622 A1
(43) Pub. Date: Apr. 15, 2021

(54) SYSTEM AND METHOD FOR CAPTURING DATA STORED ON A VOLATILE MEMORY

(71) Applicant: Toyota Motor North America, Inc., Plano, TX (US)

(72) Inventor: Stephen Paul McFarland, JR., Allen, TX (US)

(21) Appl. No.: 16/600,855

(22) Filed: Oct. 14, 2019

(51) Int. Cl. G07C 5/08

(52) U.S. Cl. CPC G07C 5/0841

(57) ABSTRACT

A system for capturing data stored on a volatile memory located within a vehicle includes one or more processors, a volatile memory, and a memory device. The memory device includes a triggering module and a storage module. The triggering module causes the one or more processors to receive a first triggering signal at a first moment in time and a second triggering signal at a second moment in time. The storage module causes the one or more processors to store at least a portion of data stored on the volatile memory at the first moment in time as a first data store in a secondary memory in response to the first triggering signal and store at least a portion data stored on the volatile memory at the second moment in time as a second data store in the secondary memory in response to the second triggering signal.

### TECHNICAL FIELD

The subject matter described herein relates, in general, to systems and methods for capturing data stored on a volatile memory, and more particularly to systems and methods for capturing data stored on a volatile memory of a vehicle.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Some current vehicles have several electronic systems and subsystems that may include several microcontrollers and memory devices. These memory devices may include volatile memory devices, such as random access memory. Additionally, some vehicles have the ability to communicate with other vehicles and/or other electronic devices. The ability to communicate with other vehicles and other electronic devices raises the possibility that these other vehicles and/or other electronic devices may be utilized to gain unauthorized access to the electronic systems and subsystems of a vehicle. This unauthorized access may include infecting the systems and subsystems of a vehicle with malware which may impact the abilities of the vehicle to operate properly. Further still, vehicles may have advanced systems and subsystems with numerous software components. A defect in one or more of these software components may also impact the abilities of the vehicle to operate properly.

### SUMMARY

This section generally summarizes the disclosure and is not a comprehensive explanation of its full scope or all its features.

In one embodiment a system for capturing data stored on a volatile memory located within a vehicle includes one or more processors, a volatile memory, and a memory device, wherein the volatile memory and the memory device are in communication with the one or more processors. The memory device includes a triggering module and a storage module. The triggering module includes instructions that cause the one or more processors to receive a first triggering signal at a first moment in time, wherein the first triggering signal is when the vehicle is powered on, and a second triggering signal at a second moment in time. The storage module includes instructions that cause the one or more processors to store at least a portion of data stored on the volatile memory at the first moment in time as a first data store in a secondary memory in response to the first triggering signal and store at least a portion of the data stored on the volatile memory at the second moment in time as a second data store in the secondary memory in response to the second triggering signal.

In another embodiment, a method for capturing data stored on a volatile memory located within a vehicle includes the steps of receiving a first triggering signal at a first moment in time, storing at least a portion of data stored on the volatile memory at the first moment in time as a first data store in a secondary memory in response to the first triggering signal, receiving a second triggering signal at a second moment in time, and storing at least a portion data stored on the volatile memory at the second moment in time as a second data store in the secondary memory in response to the second triggering signal. The first triggering signal may be initiated when the vehicle is powered on.

In yet another embodiment, a non-transitory computer-readable medium for capturing data stored on a volatile memory located within a vehicle includes instructions that when executed by one or more processors cause the one or more processors to receive a first triggering signal at a first moment in time, store at least a portion of data stored on the volatile memory at the first moment in time as a first data store in a secondary memory in response to the first triggering signal, receive a second triggering signal at a second moment in time, and store at least a portion data stored on the volatile memory at the second moment in time as a second data store in the secondary memory in response to the second triggering signal. The first triggering signal may be initiated when the vehicle is powered on.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented;

FIG. 2 illustrates one embodiment of a system for capturing data stored on a volatile memory located within a vehicle; and

FIG. 3 illustrates one embodiment of a method for capturing data stored on a volatile memory located within a vehicle.

### DETAILED DESCRIPTION

Described is a system and method that stores the contents of a volatile memory of a vehicle to assist with the detection of malware and/or software defects. Moreover, the volatile memory of a vehicle is erased when power is removed from the volatile memory. This may occur when the vehicle is turned off. If evidence of malware and/or software defects are located within the volatile memory, this evidence will be erased when the vehicle is turned off.

The system and method may capture the volatile memory at two different moments in time for analysis to determine if the volatile memory indicates evidence of malware and/or software defects. The first moment in time may be when the vehicle is first turned on and/or when one or more electronic systems or subsystems are powered up and/or finished booting. The second moment in time may be when the vehicle is turned off. By capturing the volatile memory at two separate moments in time, an analysis can be performed to determine evidence of any malware and/or software defects.

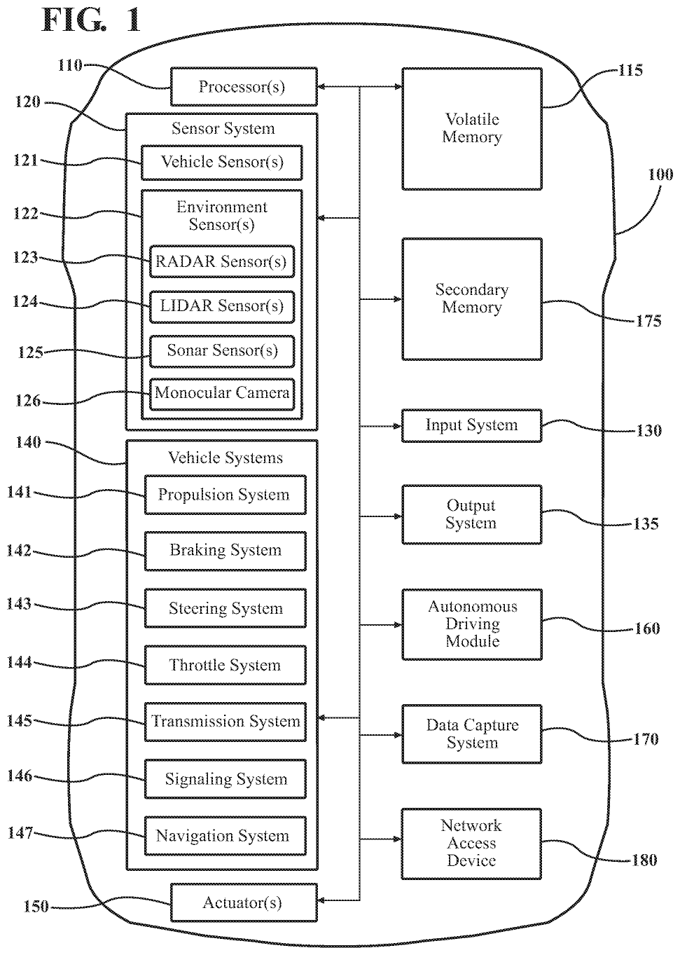

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein.

In various embodiments, the automated/autonomous systems or combination of systems may vary. For example, in one aspect, the automated system is a system that provides autonomous control of the vehicle according to one or more levels of automation such as the levels defined by the Society of Automotive Engineers (SAE) (e.g., levels 0-5). As such, the autonomous system may provide semi-autonomous control or fully autonomous control, as discussed in relation to the autonomous driving module 160.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

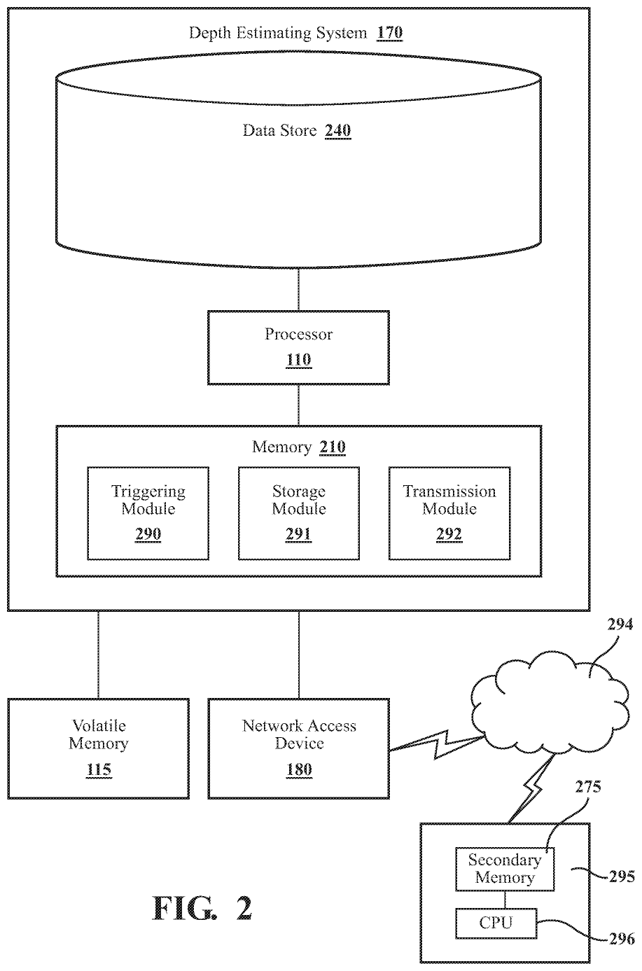

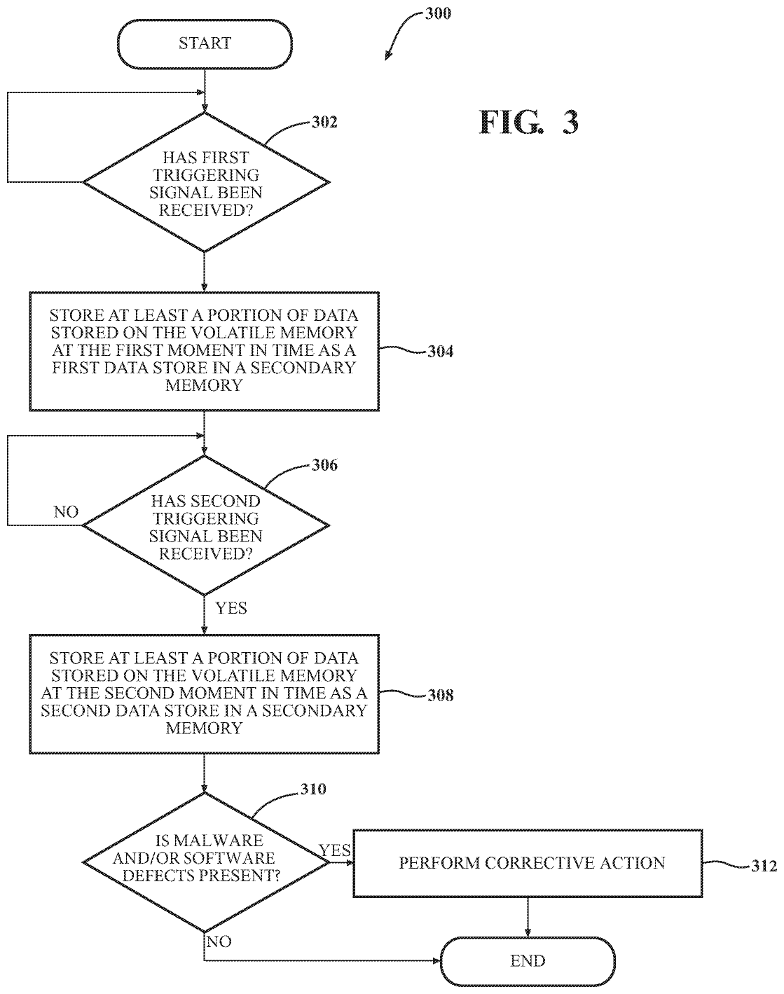

Some of the possible elements of the vehicle 100 are shown in FIG. 1 and will be described along with subsequent figures. However, a description of many of the elements in FIG. 1 will be provided after the discussion of FIGS. 2 and 3 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In this example, the vehicle 100 includes a variety of different vehicle systems 140 and sensor systems 120, that will be described in more detail later in this disclosure. The vehicle systems 140 and/or the sensor systems 120, as well as other systems, such as the autonomous driving module 160, may temporally store information on a volatile memory 115 of the vehicle 100. The volatile memory 115 may be a computer memory that requires power to maintain the stored information. The volatile memory 115 retains its contents while powered on, but when the power is interrupted, the stored data is quickly lost. Power may be provided to the volatile memory 115 when the vehicle 100 is started up, and power may be removed from the volatile memory 115 when the vehicle is shut down.

The volatile memory 115 may be a single memory structure or may be a collection of multiple memory units that may be utilized across multiple systems and subsystems of the vehicle 100, such as any of the systems and subsystems illustrated in FIG. 1. Additionally, it should be understood that the volatile memory 115 may only be a portion of the volatile memory of the vehicle 100 that is particularly subject to malware attacks or issues caused by software defects. The volatile memory 115 may be a random access memory (RAM). Alternatively, the volatile memory 115 may be a dynamic RAM and/or a static RAM.

The vehicle 100 may also include a network access device 180. The network access device 180 allows access to one or more vehicle systems and subsystems illustrated in FIG. 1 by an external device. The network access device 180, in one example, may be a device that allows for the transmission of information from the vehicle 100 to a third-party device. The transmission of information from the network access device 180 may be in the form of a wireless communication that may be to a third-party device, such as a vehicle diagnostic device, a mobile device, personal computer, tablet computer and/or server and the like. In any case, the transmission of information from the network access device 180 may be by direct wireless and/or wired communication or may be through an indirect route, such as through a distributed network such as the Internet.

In this example, a secondary memory 175 is located within the vehicle 100. As will be explained in greater detail later, the secondary memory 175 may be able to store at least a portion of the contents of the volatile memory 115 at different moments in time. The secondary memory 175 may be located remotely from the vehicle 100, such as a secondary memory 275 located on a remote server 295, as best shown in FIG. 2. The remote server 295 may be in communication with the network access device 180 of the vehicle 100 via a distributed network 294, such as the Internet.

The secondary memory 175 may be a non-volatile memory or a volatile memory that is provided with power after power is removed from the volatile memory 115. A non-volatile memory can retrieve stored information even after it has been power cycled. This differs from volatile memory, such as the volatile memory 115, in which data stored in the volatile memory 115 is erased after power is removed from the volatile memory 115. Examples of non-volatile memory include flash memory, ferroelectric RAM, and storage devices, such as magnetic, optical, and solid-state storage devices.

In either case, the vehicle 100 includes a data capture system 170. The data capture system 170 may be incorporated within any of the systems and or subsystems illustrated in FIG. 1. With reference to FIG. 2, one embodiment of the data capture system 170 is further illustrated. As shown, the data capture system 170 includes a processor 110. Accordingly, the processor 110 may be a part of the data capture system 170 or the data capture system 170 may access the processor 110 through a data bus or another communication path.

In one or more embodiments, the processor 110 is an application-specific integrated circuit that is configured to implement functions associated with a triggering module 290, a storage module 291, and/or a transmission module 292. In general, the processor 110 is an electronic processor such as a microprocessor that is capable of performing various functions as described herein. In one embodiment, the data capture system 170 includes a memory 210 that stores the triggering module 290, the storage module 291 and/or the transmission module 292. The memory 210 is a random-access memory (RAM), read-only memory (ROM), a hard disk drive, a flash memory, or other suitable memory for storing the modules 290-292. The modules 290-292 are, for example, computer-readable instructions that when executed by the processor 110 cause the processor 110 to perform the various functions disclosed herein.

Furthermore, in one embodiment, the data capture system 170 includes a data store 240. The data store 240 is, in one embodiment, an electronic data structure such as a database that is stored in the memory 210 or another memory and that is configured with routines that can be executed by the processor 110 for analyzing stored data, providing stored data, organizing stored data, and so on. Thus, in one embodiment, the data store 240 stores data used to execute various functions.

Accordingly, the triggering module 290 generally includes instructions that function to control the processor 110 to receive a first triggering signal at a first moment in time. The triggering signal may be generated by any one of the vehicle systems and subsystems shown and described in FIG. 1. In one example, the first triggering signal may be generated when the vehicle is powered on. The powering on of the vehicle could be when the vehicle is actually turned on, i.e., is keyed on, or could be after one or more systems and subsystems come online. For example, the triggering signal could be generated when the autonomous driving module 160 comes online. The autonomous driving module 160 may come online after initial booting of the autonomous driving module 160. However, it should be understood that the triggering signal can be generated at any time during the booting process. Furthermore, the first triggering signal may be generated by being initiated locally by a driver of the vehicle or remotely by a remote initiator. For example, the driver of the vehicle or a remote initiator may have a user interface that allows the manually generating of the first triggering signal. Further still, the vehicle or the remote initiator may automatically generate the first triggering signal either by a periodic schedule or may some potential detections of issues that may relate to malware or a software defect.

The storage module 291 generally includes instructions that function to control the processor 110 to store at least a portion of the data stored on the volatile memory 115 at the first moment in time as a first data store in the secondary memory 175. The storing of the first data store in the secondary memory 175 is performed in response to receiving the first triggering signal. The first data store may be an image or snapshot of a portion or even all of the volatile memory 115. The purpose of storing a portion of the data stored on the volatile memory 115 at the first moment in time is to provide a comparison that will be described later in this disclosure.

In this example, the secondary memory 175 is located within the vehicle 100. It should be understood that the secondary memory 175 may be located at a remote location. One example of this remote location may be in the form of a remote server, such as remote server 295 that contains a secondary memory 275. A portion or all of the data stored in the volatile memory 115 may be transmitted from the vehicle 100 to the secondary memory 275 that is located on a remote server 295. It should also be understood that while the remote server 295 is shown, any external third-party device could also be utilized. For example, the secondary memory 275 may be located within a portable device such as a mobile phone, tablet computer, external storage device, vehicle diagnostic device, personal computer, notebook computer, and the like.

Returning back to the triggering module 290, the triggering module 290 may also include instructions that function to control the processor 110 to receive a second triggering signal at a second moment in time. The second moment in time may be after the first moment in time. The second triggering signal may be generated when the vehicle 100 is turned off, i.e. keyed off and/or one or more systems or subsystems of the vehicle 100 are either in the process of shutting down, shut down, or scheduled to be shut down at a later time. In addition, the second triggering signal may be generated when one or more systems or subsystems of the vehicle 100 detect the potential presence of malware and/or software defects on the vehicle 100. Further still, the second triggering signal may be a driver initiated signal, wherein the driver of the vehicle 100 interacts with the input system 130 after suspecting the potential of malware and/or software defects on the vehicle 100. For example, the input system 130 may be in the form of a button that the driver of the vehicle 100 presses when the driver of the vehicle 100 suspects the potential presence of malware and/or software defects on the vehicle 100. By pressing the button, the second triggering signal is generated, resulting in storing a portion of the volatile memory 115 on the secondary memory 175 or 275. Furthermore, the second triggering signal may be generated by being initiated remotely by a remote initiator. For example, the driver of the vehicle or a remote initiator may have a user interface that allows the manually generating of the first triggering signal. Further still, the vehicle or the remote initiator may automatically generate the second triggering signal either by a periodic schedule or may some potential detections of issues that may relate to malware and/or software defects.

In response to the second triggering signal, the storage module 291 generally includes instructions that function to control the processor 110 to store at least a portion of the data stored in the volatile memory 115 at the second moment in time as a second data store in the secondary memory 175. The second data store may be an image of all or part of the volatile memory 115. As previously mentioned, the secondary memory 175 may be located within the vehicle 100 or may be separate from the vehicle, such as being located on the secondary memory 275 of the remote server 295.

As stated before, the secondary memory 175 or 275 is either a non-volatile memory or volatile memory that is provided with power after power is removed from the volatile memory 115. As such, after the vehicle 100 shuts down, the first data store and the second data store captured from the volatile memory 115 is stored within the secondary memory 175 or 275.

The first data store and the second data store may be transferred from the secondary memory 175 of the vehicle 100 using any one of a number of different devices. As stated before, the vehicle 100 includes a network access device 180 and, as such, the first data store and the second data store may be transferred to the secondary memory 275 of the remote server 295 by the distributed network 294. Of course, it should be understood that instead of storing the first data store and/or the second data store locally on the secondary memory 175, the first data store and second data store may be transmitted to the remote server 295 or other device having the secondary memory 275.

In another example, a portable device, such as a vehicle diagnostic computer, mobile device, tablet computer, notebook computer and the like may be connected to the vehicle by either a wired or wireless connection. The first data store and/or the second data store stored in the secondary memory 175 may then be transferred to the portable device so that it can be reviewed.

The memory 210 may optionally include a transmission module 292. The transmission module 292 generally includes instructions that function to control the processor 110 to transmit the first and/or second data store to a remote device, such as the remote server 295. In this example, the transmission module 292 may cause the processor 110 to transmit the first data store and/or the second data store to the remote server 295 via the network access device 180. The network access device 180 and the remote server 295 are both in communication with a network 294, which may be a distributed network, such as the Internet.

The first data store and the second data store may be utilized to determine the presence of malware and/or software defects on one or more vehicle systems and subsystems of the vehicle 100. Normally, data stored on the volatile memory 115 would be unavailable for examination to determine the presence of malware and/or software defects on one or more vehicle systems and subsystems of the vehicle 100, as any data stored on the volatile memory 115 would be effectively erased after the vehicle 100 was shut down. However, because the first data store and the second data store were captured at first and second moments in time, respectively, and stored in the secondary memory 175 and/or 275, an analysis may be performed of the first and second data stores.

Anyone of a number of different analysis methodologies to determine the presence of malware and/or software defects may be utilized in analyzing the first data store and the second data store. In one example, the first data store may be compared to the second data store to determine if variations between the first data store and the second data store are expected variations or unexpected variations. In addition to comparing the first data store to the second data store, the first data store and/or the second data store may be compared to a known or expected data store. This known or expected data store may be a data store that either is unaffected by any malware and/or software defects or is affected by malware and/or software defects. Based on similarities or differences between the first data store and/or the second data store and the known or expected data store, a determination may be made regarding the presence of malware and/or software defects.

The determination of the presence of malware and/or software defects may be performed by the processor 110 or may be performed by an external device, such as the remote server 295. Moreover, the processor 296 of the remote server 295 may be configured with instructions to perform any one of a number of different methodologies for detecting the presence of malware and/or software defects by examining the first data store and/or the second data store.

Brief mention is made regarding malware. Malware should be interpreted as being any malicious software, program, firmware, or file that is harmful to one or more systems or subsystems, such as the systems and subsystems of the vehicle 100. Malware may include computer viruses, worms, Trojan horses, ransomware, spyware, adware, and scareware, and the like. Malware may also be malicious software, program, firmware, or file that was placed in one or more of the systems and subsystems of the vehicle 100 without knowledge and/or permission of either the manufacturer of the vehicle 100 and/or the owner/driver of the vehicle 100.

As to software defects, a software defect may be an error or a bug, in the application which is created. These bugs/defects may be when actual result deviates from the expected result. Hence, any deviation from the specification mentioned in the product functional specification document is a defect. Further, these bugs/defects may be when the result of the software application or product does not meet with the end user expectations or the software requirements then it results into a bug or defect. These defects or bugs occur because of an error in logic or in coding which results into the failure or unpredictable or unanticipated results. Some issues that may be revealed by capturing the volatile may include detecting memory leak, which may include a failure in software to release discarded memory, causing impaired performance or failure.

Referring to FIG. 3, a method 300 capturing data stored on a volatile memory located within a vehicle is shown. The method 300 will be described from the viewpoint of the vehicle 100 of FIG. 1 and the data capture system 170 of FIG. 2. However, this is just one example of implementing the method 300. While the method 300 is discussed in combination with the data capture system 170, it should be appreciated that the method 300 is not limited to being implemented within the data capture system 170 but is instead one example of a system that may implement the method 300.

The method 300 begins at step 302, wherein the triggering module 290 causes the processor 110 to determine if a first triggering signal has been received. As stated before, the first triggering signal can be a signal sent by any one of a number of different systems and subsystems of the vehicle 100. In one example, the triggering signal may be initiated when the vehicle is powered on and/or when one or more systems and subsystems of the vehicle 100 are online. In one example, a system and/or subsystem is online when the system and/or subsystem has finished booting and is in its normal operating state.

Once the triggering signal has been received, the method 300 proceeds to step 304. In step 304, the storage module 291 causes the processor 110 to store at least a portion of the data stored on the volatile memory 115 as a first data store in a secondary memory, such as the secondary memory 175 of the vehicle 100 and/or the secondary memory 275 of an external device, such as the remote server 295. The first data store is essentially all or part of the data in the volatile memory 115 at a first moment in time. In the case that the first data store is stored in the secondary memory 275, this step may also involve the transmission module 292 that causes the processor 110 to transmit the first data store to the secondary memory 275 via the network access device 180. This may be accomplished by transmitting data to the remote server 295 via the distributed network 294 that is in communication with both the network access device 180 and the remote server 295.

The method 300 then proceeds to step 306, wherein the triggering module 290 causes the processor 110 to determine if a second triggering signal has been received. The second triggering signal may be initiated by one or more systems and subsystems of the vehicle 100 when the vehicle 100 either shuts down and/or when any of the systems and/or subsystems of the vehicle 100 is either scheduled to be shut down, in the process of shutting down, or have been shut down. Additionally or alternatively, the second triggering signal may be manually activated by a driver when the driver suspects the presence of malware in one or more of the systems and subsystems of the vehicle 100 or could be activated by one or more systems and subsystems of the vehicle 100 if the one or more systems and subsystems of the vehicle 100 detect the potential presence of malware and/or software defects.

Once the second triggering signal has been received, the method 300 proceeds to step 308. In step 308, the storage module 291 causes the processor 110 to store at least a portion of the data stored on the volatile memory 115 at the second moment in time as a second data store in a secondary memory, such as the secondary memory 175 and/or the secondary memory 275. If the second data store is stored in the secondary memory 275, the transmission module 292 may cause the processor 110 to transmit the second data store to a device, such as the remote server 295, to allow for the second data store to be stored in the secondary memory 275.

Optionally, the method 300 may also include step 310, in which a determination is made if malware and/or software defects is present. This determination may be made by the processor 110 of the vehicle 100 or could be made by a remote processor, such as the processor 296 of the remote server 295. As stated previously, a determination of the presence of malware and/or software defects may be made by examining the first and/or second data store stored on either the secondary memory 175 and/or the secondary memory 275.

Like mentioned before, any one of a number of different analysis methodologies to determine the presence of malware and/or software defects may be utilized in analyzing the first data store and the second data store. In one example, the first data store will be compared to the second data store to determine if variations between the first data store and the second data store are expected variations or unexpected variations. In addition to comparing the first data store to the second data store, the first data store and/or the second data store may be compared to a known or expected data store. This known or expected data store may be a data store that either is unaffected by any malware and/or software defects or is affected by malware and/or software defects. Based on similarities or differences between the first data store and/or the second data store and the known or expected data store, a determination may be made regarding the presence of malware and/or software defects.

If it is determined in step 310 that malware and/or software defects are present, the method 300 will proceed to step 312 wherein corrective action may occur. Like step 310, it should be understood that step 312 is optional. As to corrective action, a number of different actions may take place. In one example, the corrective action could include actions such as resetting and/or restarting the system, operating the system in a safe mode, uninstalling or installing additional software to mitigate issues caused by malware and/or software defects, reboot the system to default settings, etc.

FIG. 1 will now be discussed in full detail as an example environment within which the system and methods disclosed herein may operate. In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control to ensure the vehicle 100 remains within defined state constraints.

The vehicle 100 can include one or more processors 110. In one or more arrangements, the processor(s) 110 can be a main processor of the vehicle 100. For instance, the processor(s) 110 can be an electronic control unit (ECU).

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the volatile memory 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110, the data capture system 170, and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110 and/or the autonomous driving module(s) 160 may control some or all of these vehicle systems 140 and, thus, may be partially or fully autonomous.

The processor(s) 110 and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110 and/or the autonomous driving module(s) 160 may control some or all of these vehicle systems 140.

The processor(s) 110 and/or the autonomous driving module(s) 160 may be operable to control the navigation and/or maneuvering of the vehicle 100 by controlling one or more of the vehicle systems 140 and/or components thereof. For instance, when operating in an autonomous mode, the processor(s) 110 and/or the autonomous driving module(s) 160 can control the direction and/or speed of the vehicle 100. The processor(s) 110, and/or the autonomous driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine position and velocity of the vehicle 100. The autonomous driving module(s) 160 can determine the location of obstacles, obstacles, or other environmental features, including traffic signs, trees, shrubs, neighboring vehicles, pedestrians, etc.

The autonomous driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving module(s) 160 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, just to name a few possibilities. The autonomous driving module(s) 160 can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-3, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system for capturing data stored on a volatile memory located within a vehicle, the system comprising:
one or more processors;
a volatile memory in communication with the one or more processors;
a memory device in communication with the one or more processors, the memory device comprising a triggering module, the triggering module having instructions that when executed by the one or more processors cause the one or more processors to receive a first triggering signal at a first moment in time;
the memory device comprising a storage module having instructions that when executed by the one or more processors cause the one or more processors to store at least a portion of data stored on the volatile memory at the first moment in time as a first data store in a secondary memory in response to the first triggering signal;
the triggering module further having instructions that when executed by the one or more processors cause the one or more processors to receive a second triggering signal at a second moment in time; and
the storage module further having instructions that when executed by the one or more processors cause the one or more processors to store at least a portion data stored on the volatile memory at the second moment in time as a second data store in the secondary memory in response to the second triggering signal.

2. The system of claim 1, wherein the first triggering signal occurs when at least one of: the vehicle is powered on, initiated locally by a driver of the vehicle, initiated remotely by a remote initiator, and initiated by the vehicle.

3. The system of claim 1, wherein the second triggering signal occurs when at least one of: the vehicle is powered off, initiated locally by a driver of the vehicle, initiated remotely by a remote initiator, and initiated by the vehicle.

4. The system of claim 1, further comprising
a network access device in communication with the one or more processors; and
the memory device further comprising a transmission module having instructions that when executed by the one or more processors cause the one or more processors to transmit the first data store to a remote server via the network aces device, the remote server having the secondary memory and transmit the second data store to the remote server.

5. The system of claim 1, wherein the secondary memory is located within the vehicle.

6. The system of claim 1, wherein the first data store is a first image of the volatile memory at the first moment in time and the second data store is a second image of the volatile memory at the second moment in time.

7. A method for capturing data stored on a volatile memory located within a vehicle comprising the steps of:
receiving a first triggering signal at a first moment in time;
storing at least a portion of data stored on the volatile memory at the first moment in time as a first data store in a secondary memory in response to the first triggering signal;
receiving a second triggering signal at a second moment in time; and
storing at least a portion data stored on the volatile memory at the second moment in time as a second data store in the secondary memory in response to the second triggering signal.

8. The method of claim 7, wherein the first triggering signal occurs when at least one of: the vehicle is powered on, initiated locally by a driver of the vehicle, initiated remotely by a remote initiator, and initiated by the vehicle.

9. The method of claim 7, wherein the second triggering signal occurs when at least one of: the vehicle is powered off, initiated locally by a driver of the vehicle, initiated remotely by a remote initiator, and initiated by the vehicle.

10. The method of claim 7, further comprising the steps of:
transmitting the first data store to a remote server; and
transmitting the second data store to the remote server.

11. The method of claim 7, wherein the secondary memory is located within the vehicle.

12. The method of claim 7, further comprising the steps of:
comparing the first data store to the second data store; and
determining a presence of at least one of malware and software defect based on the comparison of the first data store to the second data store.

13. The method of claim 7, wherein the first data store is a first image of the volatile memory at the first moment in time and the second data store is a second image of the volatile memory at the second moment in time.

14. A non-transitory computer-readable medium for capturing data stored on a volatile memory located within a vehicle, the non-transitory computer-readable medium comprising instructions that when executed by one or more processors cause the one or more processors to:
receive a first triggering signal at a first moment in time;
store at least a portion of data stored on the volatile memory at the first moment in time as a first data store in a secondary memory in response to the first triggering signal;
receive a second triggering signal at a second moment in time; and
store at least a portion data stored on the volatile memory at the second moment in time as a second data store in the secondary memory in response to the second triggering signal.

15. The non-transitory computer-readable medium of claim 14, wherein the first triggering signal occurs when at least one of: the vehicle is powered on, initiated locally by a driver of the vehicle, initiated remotely by a remote initiator, and initiated by the vehicle.

16. The non-transitory computer-readable medium of claim 14, wherein the second triggering signal occurs when at least one of: the vehicle is powered off, initiated locally by a driver of the vehicle, initiated remotely by a remote initiator, and initiated by the vehicle.

17. The non-transitory computer-readable medium of claim 14, further comprising instructions that when executed by one or more processors cause the one or more processors to:
transmit the first data store to a remote server, the remote server having the secondary memory; and
transmit the second data store to the remote server.

18. The non-transitory computer-readable medium of claim 14, wherein the secondary memory is located within the vehicle.

19. The non-transitory computer-readable medium of claim 14, further comprising instructions that when executed by one or more processors cause the one or more processors to:
compare the first data store to the second data store; and
determine a presence of at least one of malware and software defect based on the comparison of the first data store to the second data store.

20. The non-transitory computer-readable medium of claim 14, wherein the first data store is a first image of the volatile memory at the first moment in time and the second data store is a second image of the volatile memory at the second moment in time.
